(19) United States
(12) Patent Application Publication
(10) Pub. No.: US 2016/0147357 A1
(43) Pub. Date: May 26, 2016

(54) ANTI-NOISE METHOD OF TOUCH PANEL, TOUCH PANEL AND DISPLAY DEVICE

(71) Applicant: Chengliang YE, Shenzhen, Guangdong (CN)

(72) Inventor: Chengliang YE, Shenzhen, Guangdong (CN)

(21) Appl. No.: 14/433,644

(22) PCT Filed: Nov. 21, 2014
(86) PCT No.: PCT/CN2014/091877

§ 371 Date: Apr. 4, 2015

(51) Int. Cl. G06F 3/041

(52) U.S. Cl. CPC G06F 3/0416

(57) ABSTRACT

An anti-noise method of a touch panel, a touch panel and a display device are provided. The anti-noise method includes: detecting whether an effective signal has been received; collecting a noise signal as a first signal when the effective signal has not been received; collecting the effective signal and the noise signal as a second signal when the effective signal has been received; and processing the first signal and the second signal to obtain the effective signal. By the above method, the invention can collect the noise signal generated by LCD by way of time-division and area-sharing and then obtain a pure effective signal after signal processing, the aperture ratio of the touch panel is improved, the collection of noise signal is more accurate, and more pure effective signal is obtained.

### TECHNICAL FIELD

The invention relates to the field of touch panel technology, and particularly to an anti-noise method of a touch panel, a touch panel and a display device.

### DESCRIPTION OF RELATED ART

In the touch panel field, either an embedded touch panel or an externally-mounted touch panel would inevitably encounter noise from a LCD, and a source of noise generally is the frequent turned-off and switching of gate lines and data lines.

In order to reduce the noise from the LCD, a conventional touch panel generally adopts a method such as frequency hopping, touch model optimizing or post-stage control calculation optimizing; or sensors of the touch panel are divided into two parts, i.e., main sensors each for sensing a touch operation of finger or other conductor and a noise signal, and secondary sensors each only for sensing the noise signal, by subtracting the noise signal from the sensed signal of the main sensors, a pure touch signal can be obtained consequently.

In the above method, the secondary sensors would be arranged in an area not to be touched, i.e., a non-display area of the LCD, but it would reduce the display area of the LCD. Correspondingly, a total area of the LCD also would be reduced, and a part of the area would be let out for the secondary sensors, but the secondary sensors occupied a small area would not accurately collect the noise signal of the whole LCD panel.

### SUMMARY

A technical problem primarily to be solved by the invention is to provide an anti-noise method of a touch panel, a touch panel and a display device, which can collect a noise signal by time-division and area-sharing and thereby obtain a pure touch signal.

In order to solve the technical problem, a technical solution proposed by the invention is to provide an anti-noise method of a touch panel. The anti-noise method includes: receiving a signal and detecting the received signal whether contains an effective signal; if the received signal does not contain the effective signal, periodically collecting at least two noise signals, performing an averaging operation on the at least two noise signals to obtain an average signal and taking the average signal as a first signal; if the received signal contains the effective signal, saving the received signal as a second signal; performing a difference operation between the first signal and the second signal to obtain a difference signal and taking the difference signal as the effective signal.

In an exemplary embodiment, a method for detecting the received signal whether contains the effective signal includes: comparing the received signal with a pre-stored threshold signal to judge the received signal whether is smaller than the threshold signal; when the received signal is smaller than the threshold signal, determining that the received signal does not contain the effective signal; when the received signal is larger than or equal to the threshold value, determining that the received signal contains the effective signal.

In order to solve the above technical problem, a technical solution proposed by the invention is to provide an anti-noise method of a touch panel. The anti-noise method includes: receiving a signal and detecting the received signal whether contains an effective signal; if the received signal does not contain the effective signal, saving the received signal as a first signal; if the received signal contains the effective signal, saving the received signal as a second signal; processing the first signal and the second signal to obtain the effective signal.

In an exemplary embodiment, a method for detecting the received signal whether contains the effective signal includes: comparing the received signal with a pre-stored threshold signal to judge the received signal whether is smaller than the threshold value; when the received signal is smaller than the threshold signal, determining that the received signal does not contain the effective signal; when the received signal is larger than or equal to the threshold signal, determining that the received signal contains the effective signal.

In an exemplary embodiment, processing the first signal and the second signal includes: performing a difference operation between the first signal and the second signal to obtain a difference signal and taking the difference signal as the effective signal.

In an exemplary embodiment, the anti-noise method further includes: if the received signal does not contain the effective signal, periodically collecting at least two noise signals, performing an averaging operation on the at least two noise signals to obtain an average signal and taking the average signal as the first signal.

In an exemplary embodiment, the effective signal is a touch signal.

In order to solve the above technical problem, another technical solution proposed by the invention is to provide a touch panel. The touch panel includes: sensors arranged in an array and each configured for receiving a signal; and a processor connected with the sensors and configured for detecting the received signal whether contains an effective signal, saving the received signal as a first signal if the received signal does not contain the effective signal, and saving the received signal as a second signal if the received signal contains the effective signal. The processor further is configured for processing the first signal and the second signal to obtain the effective signal.

In an exemplary embodiment, the processor includes a memory configured for pre-storing a threshold signal; correspondingly, the processor further is configured for comparing the received signal with the pre-stored threshold signal to judge the received signal whether is smaller than the threshold signal, determining that the received signal does not contain the effective signal when the received signal is smaller than the threshold signal, and determining that the received signal contains the effective signal when the received signal is larger than or equal to the threshold signal.

In an exemplary embodiment, the processor includes a subtracter configured for performing a difference operation between the first signal and the second signal to obtain a difference signal and taking the difference signal as the effective signal.

In an exemplary embodiment, the processor further is configured for periodically collecting at least two noise signals and performing an averaging operation on the at least two noise signals to obtain an average signal when the received signal does not contain the effective signal, and taking the average signal as the first signal.

In order to solve the above technical problem, still another technical solution proposed by the invention is to provide a display device. The display device includes: a display device main body and a touch panel disposed on a surface of the display device main body. The touch panel includes sensors arranged in an array and a processor. The sensors each are configured for receiving a signal. The processor is connected with the sensors and configured for detecting the received signal whether contains an effective signal, saving the received signal as a first signal if the received signal does not contain the effective signal, and saving the received signal as a second signal if the received signal contains the effective signal. The processor further is configured for processing the first signal and the second signal to obtain the effective signal.

In an exemplary embodiment, the processor includes a memory configured for pre-storing a threshold signal. The processor further is configured for comparing the received signal with the pre-stored threshold signal to judge the received signal whether is smaller than the threshold signal, determining that the received signal does not contain the effective signal when the received signal is smaller than the threshold signal, and determining that the received signal contains the effective signal when the received signal is larger than or equal to the threshold signal.

In an exemplary embodiment, the processor includes a subtracter configured for performing a difference operation between the first signal and the second signal to obtain a difference signal and taking the difference signal as the effective signal.

In an exemplary embodiment, the processor further is configured for periodically collecting at least two noise signals and performing an averaging operation on the at least two noise signals to obtain an average signal when the received signal does not contain the effective signal, and taking the average signal as the first signal.

The efficacy of the invention is that: different from the prior art, the invention receives a signal and detects the received signal whether contains an effective signal; if the received signal does not contain the effective signal, saves the received signal as a first signal; if the received signal contains the effective signal, saves the received signal as a second signal; and finally processes the first signal and the second signal to obtain the effective signal. By this method, the invention can collect the noise signal generated by the LCD by way of time-division and area-sharing, i.e., use a sensor in the same area to receive the first signal and the second signal respectively when being touched or being-not touched by a conductor and then obtain the pure effective signal after signal processing. Accordingly, it is not necessary to divide the sensors into a noise signal collecting area and an effective signal colleting area like the prior art, so that an area of the display area of the touch panel can be increased up to the sum of the conventional noise signal collecting area and effective signal collecting area, the aperture ratio is improved. Moreover, the whole panel is used to collect the noise signal, the collection of noise signal is more accurate and the obtained effective signal is more pure.

### BRIEF DESCRIPTION OF THE DRAWINGS

In order to more clearly illustrate the technical solutions of various embodiments of the present invention, drawings will be used in the description of embodiments will be given a brief description below. Apparently, the drawings in the following description only are some embodiments of the invention, the ordinary skill in the art can obtain other drawings according to these illustrated drawings without creative effort. In the drawings:

FIG. 1 is a flowchart of a first embodiment of an anti-noise method of a touch panel of the invention;

FIG. 2 is a coordinates diagram of “signal value-time” of a noise signal in the first embodiment of the invention;

FIG. 3 is a flowchart of a second embodiment of an anti-noise method of a touch panel of the invention;

FIG. 4 is a coordinates diagram of “signal value-time” with a threshold signal in the second embodiment of the invention;

FIG. 5 is a schematic view of performing a difference operation between a first signal and a second signal in the step 304 of the second embodiment of the invention;

FIG. 6 is a schematic view of matching of the first signal with the second signal of the second embodiment of the invention;

FIG. 7 is a flowchart of a third embodiment of an anti-noise method of a touch panel of the invention;

FIG. 8 is a schematic structural view of a fourth embodiment of a touch panel of the invention; and

FIG. 9 is a schematic structural view of a fifth embodiment of a display device of the invention.

### DETAILED DESCRIPTION OF EMBODIMENTS

In the following, with reference to accompanying drawings of embodiments of the invention, technical solutions in the embodiments of the invention will be clearly and completely described. Apparently, the embodiments of the invention described below only are a part of embodiments of the invention, but not all embodiments. Based on the described embodiments of the invention, all other embodiments obtained by ordinary skill in the art without creative effort belong to the scope of protection of the invention.

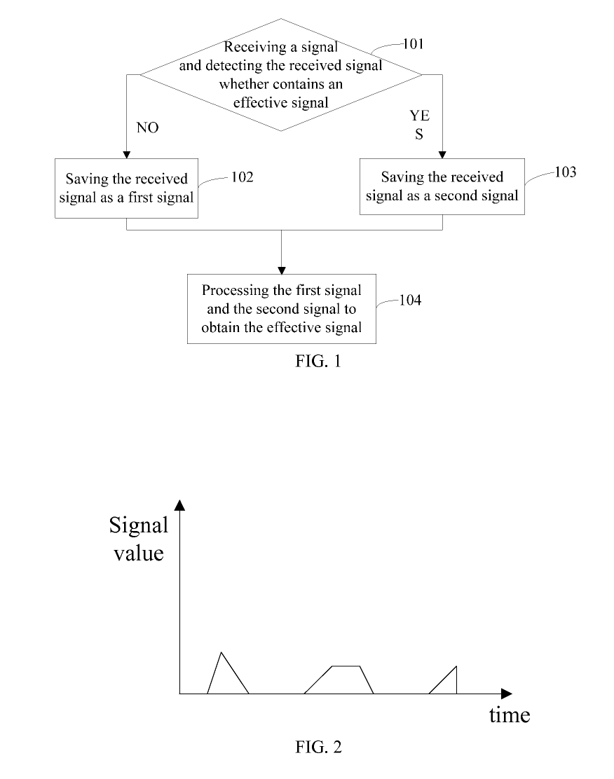

Referring to FIG. 1, a first embodiment of an anti-noise method of a touch panel of the invention includes following steps 101-104.

Step 101: receiving a signal and detecting the received signal whether contains an effective signal; if the received signal does not contain the effective signal, goes to step 102; if the received signal contains the effective signal, goes to step 103.

The operation of signal receiving is performed during the device is at ON-state, and regardless of whether an effective signal has been received or not, the signal is always received.

In this embodiment, the effective signal mainly is a touch signal, i.e., a signal obtained by a sensor obtained when a finger or other conductor touches the touch panel. Because touch screens are classified into vector pressure sensor touch screen, resistive touch screen, capacitive touch screen, infrared touch screen and surface acoustic wave touch screen and so on, the effective signal can be a pressure signal, a current signal, an infrared signal, an acoustic signal or other signal such as a radio-frequency signal.

Taking the capacitive touch screen as an example, when the touch panel has not received the effective signal, a noise signal mainly comes from the frequent turned-off or switching of gate lines and data lines of a LCD. At this time, a signal value of the noise signal is discontinuous and fluctuant and has small amplitude as shown in FIG. 2. Accordingly, by detecting continuity or amplitude magnitude of the received signal, the received signal whether contains the effective signal can be determined.

Step 102: saving the received signal as a first signal.

When the sensor has not received the effective signal, the received signal is saved as the first signal. In this embodiment, a processor can analyze the noise signal collected by the sensor, because the noise signal is generated because of frequent turned-off or switching of the gate lines and the data lines of the LCD, the noise signal may be a periodically varying signal or other noise signal and have a corresponding noise characteristics, and therefore the processor may only collect the signal in a single cycle or collect the signal in a period of time and then analyze the collected signal, by reference to the noise characteristics, only save the single cycle of or the period of noise signal. Of course, because it is uncertain that the signal is periodic variation or random variation, it may be that the signal is continuously collected and saved instead.

Step 103: saving the received signal as a second signal.

When the sensor has received the effective signal, the received signal is saved as the second signal. Because the noise is existed at any time, when the sensor collects the effective signal, the noise signal also is collected at the same time, and therefore the second signal is the combination of the effective signal and the noise signal.

Step 104: processing the first signal and the second signal to obtain the effective signal.

A processing method may be that performing a filter processing and amplitude correction on the second signal to obtain a pure effective signal, or comparing with the first signal and filtering out a signal same as the first signal from the second signal.

Different from the prior art, this embodiment receives a signal and detects the received signal whether contains an effective signal; if the received signal does not contain the effective signal, saves the received signal as a first signal; if the received signal contains the effective signal, saves the received signal as a second signal; and finally processes the first signal and the second signal to obtain the effective signal. By adopting this solution, this embodiment can collect the noise signal generated by LCD by way of time-division and area-sharing, i.e., use a sensor in the same area to receive the first signal and the second signal respectively when being touched and being-not touched by a conductor and then obtain a pure effective signal after signal processing. Accordingly, it is not necessary to divide sensors into a noise signal collecting area and an effective signal collecting area like the prior art, so that the area of the display area of the touch panel can be increased up to a sum of the conventional noise signal collecting area and effective signal collecting area, the aperture ratio of the touch panel is increased. Moreover, the whole panel is used to collect the noise signal, the collection of noise signal is more accurate and the obtained effective signal is more pure.

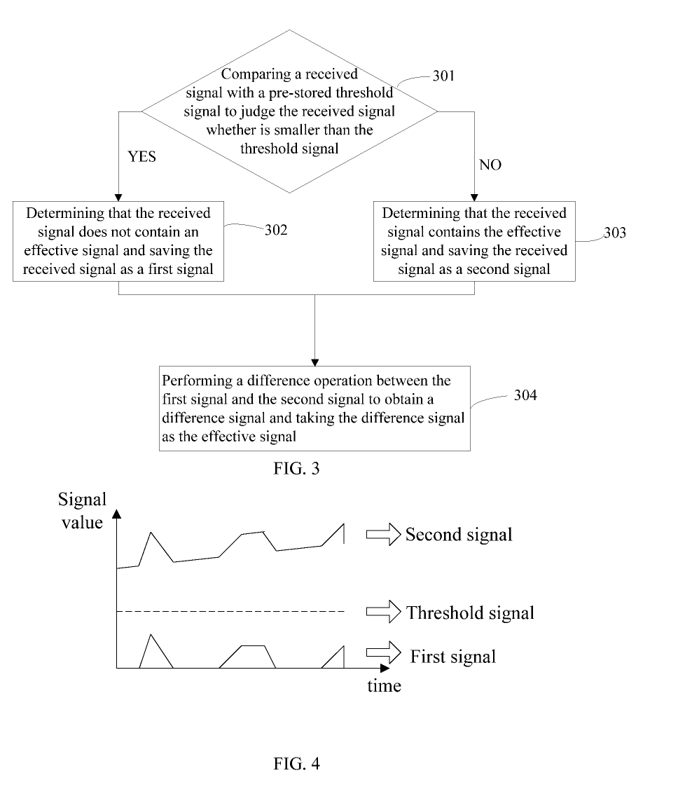

Referring to FIG. 3, a second embodiment of the anti-noise method of a touch panel of the invention includes following steps 301-304.

Step 301: comparing a received signal with a pre-stored threshold signal to judge the received signal whether is smaller than the threshold signal; if YES, goes to step 302, and if NO, goes to step 303.

An amplitude of the threshold signal is set according to the first signal and the second signal, and generally is between the first signal and the second signal. As shown in FIG. 4, the first signal is a noise signal and thus a signal value thereof is discontinuous and fluctuant and has small amplitude; the second signal is the sum of an effective signal and the noise signal, and because of the existence of the noise signal, the second signal also is fluctuant but an amplitude thereof is large. Accordingly, based on the amplitudes of the first signal and the second signal, the threshold signal having an amplitude between the amplitudes of the first signal and the second signal can be set and pre-stored, and during receiving a signal, the received signal can be determined as the first signal or the second signal by comparing the received signal with the threshold value.

Step 302: when the received signal is smaller than the threshold value, determining that the received signal does not contain an effective signal and saving the received signal as a first signal.

Step 303: when the received signal is larger than or equal to the threshold value, determining the received signal contains the effective signal and saving the received signal as a second signal.

When comparing the amplitudes of the received signal and the threshold signal, because the first signal and the second signal both are fluctuant, maximum values, minimum values or average values of the first signal and the second signal can be used to compare with the threshold value. For example, it may be set that when the maximum value of the received signal is smaller than the threshold signal, the received signal is determined as a noise signal and saved as the first signal; and when the minimum value of the received signal is larger than or equal to the threshold value, the received signal is determined as the sum of the effective signal and the noise signal and saved as the second signal.

Step 304: performing a difference operation between the first signal and the second signal to obtain a difference signal and taking the difference signal as the effective signal.

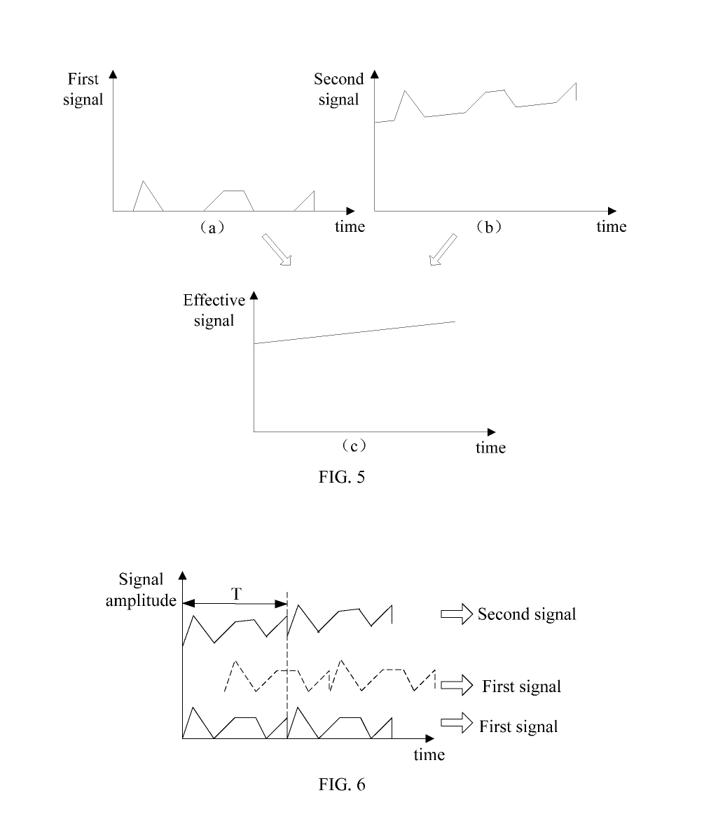

As shown in FIG. 5, FIG. 5(a) is a coordinates diagram of the first signal, FIG. 5(b) is a coordinates diagram of the second signal, and FIG. 5(c) is a coordinates diagram of the effective signal. Because the collections of the first signal and the second signal are time-divided, the two signals are not matched on the time coordinates (X-axis in FIG. 5). However, because the generation of the first signal is periodic and the noise in the second signal is about the same as the first signal in one cycle, for example, it may be that comparing multiple extremums of the first signals with multiple extremums of the second signal, so that the first signal and the second signal are made to be periodically matched and thereby a time of each noise signal in each cycle can be determined.

Thereafter, a difference operation is performed between the first signal and the second signal, and based on the matched first signal and the second signal, signals at each time point are performed with a subtracting operation, i.e., an amplitude of the first extremum of the second signal subtracts an amplitude of the first extremum of the first signal, an amplitude of the second extremum of the second signal subtracts an amplitude of the second extremum of the first signal, and so on. As a result, a corresponding difference signal is obtained and the obtained difference signal will be taken as the effective signal.

Specifically, as shown in FIG. 6, during matching the first signal with the second signal, extremums of the signals are correspondingly matched. For example, the extremums of the first signal as denoted by solid line in the figure can match with the second signal while the first signal as denoted by dashed line cannot match with the second signal, and therefore the difference operation is performed between the first signal and the second signal just only the extremums of the first signal are matched with that of the second signal.

Different from the prior art, this embodiment compares a received signal with a threshold value to determine the received signal whether contains an effective signal; when the effective signal has not been received, saves the received noise signal as a first signal; when the effective signal has been received, saves the received signal as a second signal; processes the first signal and the second signal by extremums matching and performs a difference operation between the first signal and the second to filter out the first signal from the second signal and thereby obtains a pure effective signal. By adding the matching of the extremums for determining the first signal and the second signal, during filtering out the first signal from the second signal, signal amplitudes of corresponding times in a same cycle of the first signal can be accurately filtered out, rather than only an average value or an approximate value of the first signal is filtered out, so that the matching of the first signal with the second signal is more accurate, and the filtering is more accurate and the obtained effective signal is more pure.

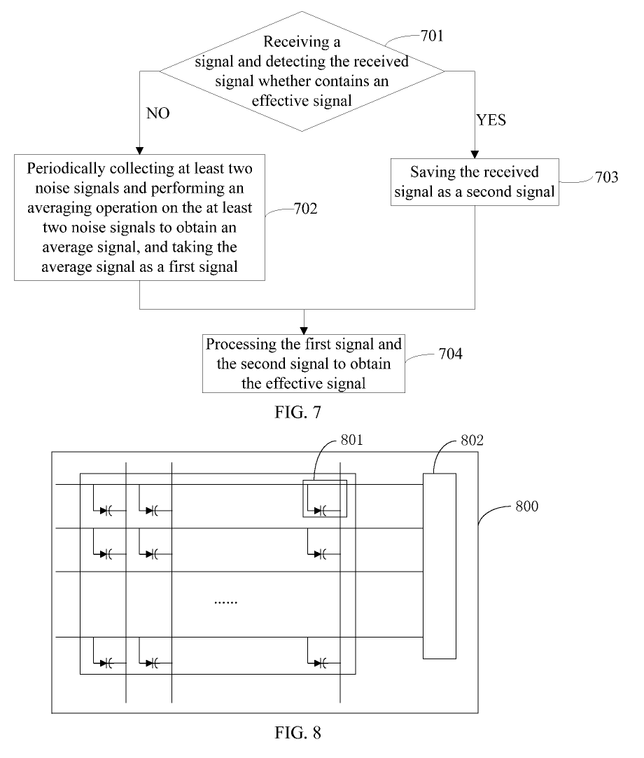

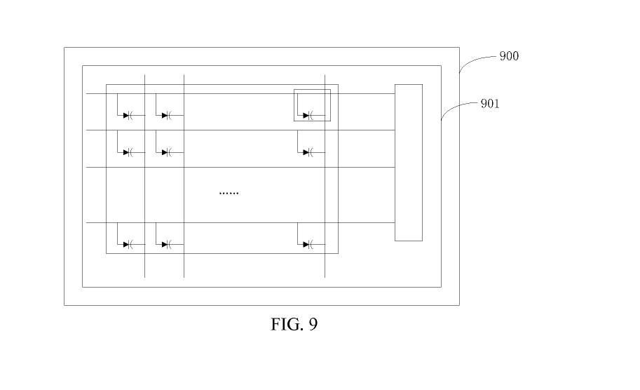

Referring to FIG. 7, a third embodiment of the anti-noise method of a touch panel of the invention includes following steps 701-704.

Step 701: receiving a signal and detecting the received signal whether contains an effective signal; if the received signal does not contain the effective signal, goes to step 702, and if the received signal contains the effective signal, goes to step 703.

Step 702: periodically collecting at least two noise signals, performing an averaging operation on the at least two noise signals to obtain an average signal and taking the average signal as a first signal.

Because of the randomness and discontinuity of the noise signal, the noise signal generated at different positions of the touch panel and/or at different times may be different, in order to more convenient to obtain the noise signal and separate the noise signal from the effective signal, this embodiment adopts the method of periodically collecting at least two noise signals and performing an averaging operation thereon.

Specifically, the method of comparing with the threshold signal in the second embodiment also can be adopted herein, when the received signal is smaller than the threshold signal, the received signal is determined as a noise signal, and the noise signal is periodically collected. It is indicated that: the receiving of signal is constant and only the collecting of signal is periodic.

Before the effective signal has been received, each collected noise signal is performed the averaging operation with previous collected noise signal(s) and the averaging result is saved as the first signal, so that the first signal saved in a memory is constantly updated and varied along with the new collected noise signal, and it is predictable that when the noise signals are collected enough, the first signal in the memory would remain steady.

In addition, a period of collecting the noise signal can be arbitrarily set, the smaller the period is, the more accurate the collected noise signal is, and when the period is small enough, it can be regarded as continuous collecting. That is, the collected continuous or discontinuous signal can be performed with integrating and averaging, so that the collected noise signal is more accurate.

Step 703: saving the received signal as a second signal.

Step 704: processing the first signal and the second signal to obtain the effective signal.

Because the first signal is an average value of periodically collected multiple noise signals, during processing the first signal and the second signal, the second signal only needs to subtract a fixed average value to thereby obtain the effective signal.

Different from the prior art, before the effective signal has not been received, this embodiment periodically collects a noise signal, performs an averaging operation on multiple collected noise signals to obtain an average signal and takes the average signal as a first signal, so that the obtaining of the first signal is more convenient and fast. In addition, during processing the first signal and the second signal, because the first signal is the average signal of multiple collected noise signals, it is more easily to filter out the first signal from the second signal, the cumbersome process of extremums comparing and matching can be avoid, a response of the touch panel to the second signal is more rapid and the burden of the processor is reduced.

Referring to FIG. 8, in a fourth embodiment of a touch panel of the invention, the touch panel includes: sensors 801 arranged in an array and a processor 802. Each row of sensors are connected to the processor 802 by one data line.

The sensors 801 arranged in an array each are configured (i.e., structured and arranged) for receiving a signal.

The processor 802 is configured for detecting the received signal whether contains an effective signal, saving the received signal as a first signal if the received signal does not contain the effective signal, and saving the receiving signal as a second signal if the received signal contains the effective signal.

Moreover, the processor 802 further is configured for processing the first signal and the second signal to obtain the effective signal.

In other embodiment, the processor may be further configured for comparing the received signal with a pre-stored threshold signal to judge the received signal whether is smaller than the threshold signal; if the received signal is smaller than the threshold signal, determining that the received signal does not contain the effective signal; and if the received signal is larger than or equal to the threshold signal, determining that the received signal contains the effective signal.

In other embodiment, the processor may further include a subtracter. The subtracter is configured for performing a difference operation between the first signal and the second signal to obtain a difference signal and taking the difference signal as the effective signal.

In other embodiment, the processor may be further configured for periodically collecting at least two noise signals and performing an averaging operation on the at least two noise signals to obtain an average signal when the received signal does not contain the effective signal, and taking the average signal as the first signal.

The touch panel in this embodiment is a terminal based on the anti-noise method of a touch panel described in the foregoing embodiments, and therefore the foregoing embodiments are suitable for this embodiment.

Different from the prior art, this embodiment detects whether an effective signal has been received, collects a noise signal as a first signal if the effective signal has not been received, collects the noise signal and the effective signal as a second signal if the effective signal has been received, and then processes the first signal and the second signal to obtain the effective signal. By adopting such means, this embodiment can collect the noise signal generated from the LCD by time-division and area-sharing, i.e., use a sensor in the same area to receive the first signal and the second signal respectively when being touched or being-not touched by a conductor and obtain a pure effective signal after signal processing. Accordingly, it is not necessary to divide the sensors into a noise signal collecting area and an effective signal collecting area like in the prior art, the area of the display area of the touch panel can be increased up to be the sum of the conventional noise signal collecting area and effective signal collecting area, the aperture ratio of the touch panel is increased. Moreover, the whole panel is used to collect the noise signal, the collection of noise signal is more accurate, and thus the obtained effective signal is more pure.

Referring to FIG. 8, in a fifth embodiment of a display device of the invention, the display device includes a display device main body 900 and a touch panel 901 disposed on a surface of the display device main body 900.

The touch panel is any one of the touch panels in the first to fourth embodiments, and thus will not be repeated herein.

Different from the prior art, the display device in this embodiment includes a touch panel, and the touch panel detects an effective signal whether has been received, collects a noise signal as a first signal if the effective signal has not been received, collects the noise signal and the effective signal as a second signal if the effective signal has been received, and then processes the first signal and the second signal to obtain the effective signal. By adopting such means, this embodiment can collect the noise signal generated from the LCD by time-division and area-sharing, i.e., use a sensor in the same area to receive the first signal and the second signal respectively when being touched or being-not touched by a conductor and obtain a pure effective signal after signal processing. Accordingly, it is not necessary to divide the sensors into a noise signal collecting area and an effective signal collecting area like in the prior art, the area of the display area of the touch panel can be increased up to be the sum of the conventional noise signal collecting area and effective signal collecting area, the aperture ratio of the touch panel is increased. Moreover, the whole panel is used to collect the noise signal, the collection of noise signal is more accurate, and thus the obtained effective signal is more pure.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. An anti-noise method of a touch panel, comprising:
receiving a signal and detecting the received signal whether contains an effective signal;
if the received signal does not contain the effective signal, periodically collecting at least two noise signals, performing an averaging operation on the at least two noise signals to obtain an average signal and taking the average signal as a first signal;
if the received signal contains the effective signal, saving the received signal as a second signal;
performing a difference operation between the first signal and the second signal to obtain a difference signal and taking the difference signal as the effective signal.

2. The anti-noise method as claimed in claim 1, wherein a method for detecting the received signal whether contains the effective signal comprises:
comparing the received signal with a pre-stored threshold signal to judge the received signal whether is smaller than the threshold signal;
when the received signal is smaller than the threshold signal, determining that the received signal does not contain the effective signal;
when the received signal is larger than or equal to the threshold value, determining that the received signal contains the effective signal.

3. An anti-noise method of a touch panel, comprising:
receiving a signal and detecting the received signal whether contains an effective signal;
if the received signal does not contain the effective signal, saving the received signal as a first signal;
if the received signal contains the effective signal, saving the received signal as a second signal;
processing the first signal and the second signal to obtain the effective signal.

4. The anti-noise method as claimed in claim 3, wherein a method for detecting the received signal whether contains the effective signal comprises:
comparing the received signal with a pre-stored threshold signal to judge the received signal whether is smaller than the threshold value;
when the received signal is smaller than the threshold signal, determining that the received signal does not contain the effective signal;
when the received signal is larger than or equal to the threshold signal, determining that the received signal contains the effective signal.

5. The anti-noise method as claimed in claim 3, wherein processing the first signal and the second signal comprises:
performing a difference operation between the first signal and the second signal to obtain a difference signal and taking the difference signal as the effective signal.

6. The anti-noise method as claimed in claim 3, further comprising:
if the received signal does not contain the effective signal, periodically collecting at least two noise signals, performing an averaging operation on the at least two noise signals to obtain an average signal and taking the average signal as the first signal.

7. The anti-noise method as claimed in claim 3, wherein the effective signal is a touch signal.

8. A touch panel comprising:
sensors, arranged in an array and each configured for receiving a signal;
a processor, connected with the sensors and configured for detecting the received signal whether contains an effective signal, saving the received signal as a first signal if the received signal does not contain the effective signal, and saving the received signal as a second signal if the received signal contains the effective signal;
wherein the processor further is configured for processing the first signal and the second signal to obtain the effective signal.

9. The touch panel as claimed in claim 8, wherein the processor comprises a memory configured for pre-storing a threshold signal;
the processor further is configured for comparing the received signal with the pre-stored threshold signal to judge the received signal whether is smaller than the threshold signal, determining that the received signal does not contain the effective signal when the received signal is smaller than the threshold signal, and determining that the received signal contains the effective signal when the received signal is larger than or equal to the threshold signal.

10. The touch panel as claimed in claim 8, wherein the processor comprises a subtracter configured for performing a difference operation between the first signal and the second signal to obtain a difference signal and taking the difference signal as the effective signal.

11. The touch panel as claimed in claim 8, wherein the processor further is configured for periodically collecting at least two noise signals and performing an averaging operation on the at least two noise signals to obtain an average signal when the received signal does not contain the effective signal, and taking the average signal as the first signal.

11-15. (canceled)
